(19) United States
(12) Patent Application Publication
(10) Pub. No.: US 2007/0279777 A1
(43) Pub. Date: Dec. 6, 2007

(54) SLM STRUCTURE COMPRISING SEMICONDUCTING MATERIAL

(75) Inventor: Torbjorn Sandstrom, Pixbo (SE)

Correspondence Address: HAYNES BEFFEL & WOLFELD LLP, P O BOX 366, HALF MOON BAY, CA, 94019, US

(73) Assignee: Micronic Laser Systems AB, Taby (SE)

(21) Appl. No.: 11/766,010

(22) Filed: Jun. 20, 2007

Related U.S. Application Data
(63) Continuation-in-part of application No. PCT/SE04/01963, filed on Dec. 21, 2004.

(51) Int. Cl. G02B 7/182

(52) U.S. Cl. 359/871

(57) ABSTRACT

We disclose a method for stabilizing against a drift of a deflection of a micromirror device having an electrostatic actuator, including the actions of: providing an actuator including at least two members beneath said micromirror and at least one electrode beneath said micromirror, at least one of said at least two members being formed of a semiconducting material, providing a surface layer on said at least one semiconducting member facing towards said other member of said actuator, said surface layer having a density of carriers being 10¹⁷ cm³ or higher.

### PRIORITY CLAIM

This application claims priority as a continuation-in-part of PCT Application No. PCT/SE2004/001963, entitled “SLM Structure Comprising Semiconducting Material” by inventor Torbjorn Sandstrom filed on 21 Dec., 2004, designating the United States and submitted in English.

### TECHNICAL FIELD

The present invention relates to spatial light modulators (SLMs). In particular it relates to multivalued SLMs actuated with an analog voltage where said SLM comprising a semiconducting material in its structure.

### BACKGROUND OF THE INVENTION

SLMs with micromirror are well known in the art; for instance, see U.S. Pat. No. 6,747,783 by the same applicant as the present invention. SLMs can be said to be actuated in two distinct ways, analog actuation and digital actuation. In analog actuation an electrostatic force between an electrode and the mirror element is used to deflect the mirror element to a plurality of deflection states larger than two. The mirror position, or the degree of deflection, during actuation is determined by a balance between the actuation force and a spring constant of a support of the mirror element, for instance a hinge. Said mirror element is preferably set to a number of states between a fully deflected state and a non deflected state, where said fully deflected state is not determined by a fixed stop.

In digital actuation, there are only two distinct deflection states of the mirror, fully on or fully off. The fully on state may be determined by a fixed stop, i.e., a high enough actuation force is applied in order to drive the mirror element to a fixed stop. Such a structure is sometimes referred to as a DMD structure (Digital Micromirror Device) and in such devices there are no deflection states in between the fully on and fully off states.

Traditionally, said SLM is manufactured in an aluminum alloy, i.e., the actuator as well as the mirror element and the hinge element are made of said aluminum alloy. Said aluminum alloy has been shown to have some anelastic behavior, i.e., it has certain memory effects that makes the deflection of the mirror element for a specific driving voltage dependent not only on said voltage value but also on the history of applied voltage values. It could be thought of as a hysteresis effect, although it is generally more complex in its time dependence. It seems most metals show some amount of anelastic behavior, not only the traditionally used aluminum alloy. A material that does not show any measurable anelastic behavior is monocrystalline silicon. Silicon has several attractive properties, including perfect elastic behavior at room temperature, well-developed technology for etching, conduction of electricity, and a reasonable reflection of DUV electromagnetic radiation.

However, one problem with the use of mono-crystalline silicon in actuators and/or mirror elements in high precision analog SLMs is that the surface potential is not stable. Said surface potential has been shown by experiments to vary as much as 1 V due to charges sitting on the surface, e.g., ionized molecules from air or electrons trapped at or in the native oxide of the silicon surface. Such a difference in surface potential gives a shift in actuating voltage for the same deflection, i.e., a drift in the characteristics of the actuator. Said shift may vary with time, temperature, electromagnetic radiation exposure, purging and an applied voltage history. All this together makes an SLM manufactured partly or completely of a semiconducting monochrystalline material, such as monochrystalline silicon very difficult to use for high precision applications.

Thus, it is desirable to develop an SLM structure manufactured at least partly of a semiconducting material, which does not have the above mentioned problem with the drift in characteristics.

### SUMMARY OF THE INVENTION

Accordingly, one objective of the present invention is an SLM structure manufactured at least partly of a semiconducting material with no drift in characteristics, or one with a drift that is hardly measurable.

This objective, among others, is attained by a method for stabilizing against a drift of a deflection of a micromirror device having an electrostatic actuator, including the actions of: providing an actuator including at least two members beneath said micromirror and at least one electrode beneath said micromirror, at least one of said at least two members being formed of a semiconducting material, providing a surface layer on said at least one semiconducting member facing towards said other member of said actuator, said surface layer having a density of carriers being 10¹⁷ cm⁻³ or higher. By “beneath said micromirror” we refer to a specific orientation of a micromirror device. The function of an inverted micromirror device, or any other orientation of the same device, is of course independent of the geometrical orientation and “beneath” should be interpreted in this context.

Further characteristics of the invention and advantages thereof will be evident from the detailed description of preferred embodiments of the present invention given hereinafter and the accompanying FIGS. 1-8, which are given by way of illustration only, and thus are not limitative of the present invention.

### BRIEF DESCRIPTION OF THE DRAWINGS

FIG. 1 depicts schematically a top view of three mirrors in a micromirror array.

FIG. 2 depicts a side view of the micromirrors along A-A in FIG. 1 with one mirror in an addressed state.

FIG. 3 depicts a side view of the micromirrors along A-A in FIG. 1 with no applied voltage.

FIG. 4 depicts a band diagram where the voltage shift is created by charges on the surface of the semiconductor.

FIG. 5 depicts the same band diagram as in FIG. 4, but with a degenerated “metallic” layer facing the gap.

FIG. 6a depicts a band diagram of a near degenerated inverted P silicon.

FIG. 6b depicts a band diagram of an n-silicon which is driven to create a conductive layer at the surface by a perpendicular electric field.

FIG. 6c depicts a band diagram of a metal film shielding the semiconductor from charges on the surface.

FIG. 6d depicts a band diagram of a degenerated semiconductor throughout its volume.

FIG. 6e depicts a band diagram of a near-degenerated conducting surface layer created by a thin film with a high concentration of fixed ions.

FIG. 7 depicts a side view of the inventive micromirrors along A-A in FIG. 1.

FIG. 8 depicts a side view of another inventive embodiment of a micromirror.

FIG. 9 depicts use of a phase step to reduce stray reflections from space between micromirrors.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

A micromirror device may in at least one example embodiment of the invention be an SLM. For instance, said SLM may be used in lithography formation of patterns, digital or analog actuation, according to well known techniques to a person skilled in the art and therefore needs no further clarification in this context.

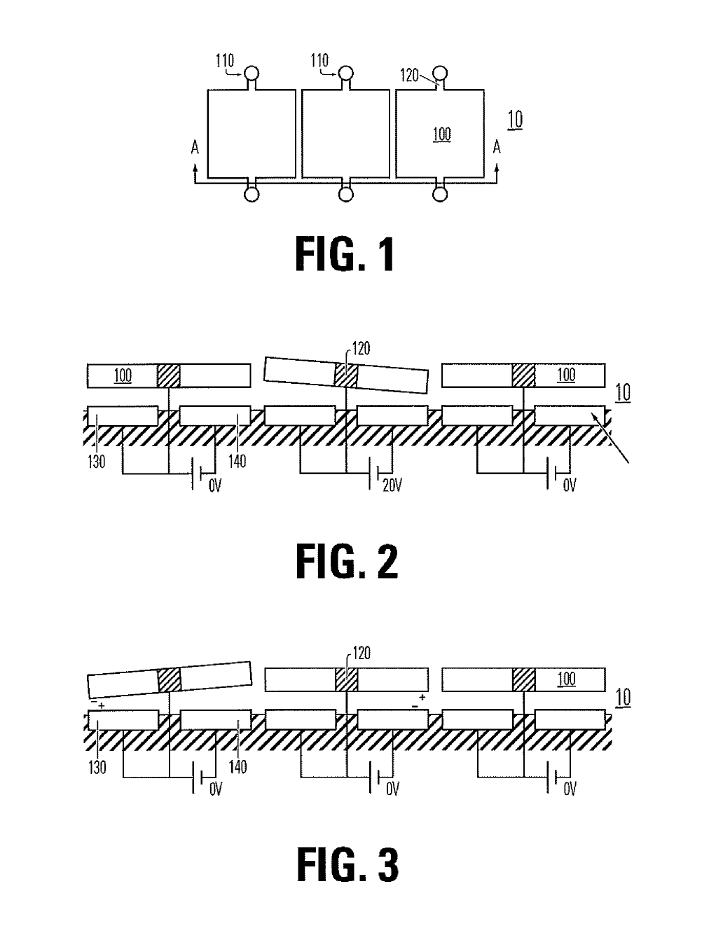

FIG. 1 depicts a top view of three mirrors 100 in a micromirror array 10, only three mirrors 100 are illustrated for reason of clarity, in a real micromirror array the number of mirrors may be as many as several millions.

The micromirrors illustrated in FIG. 1 are hinged mirrors which may be deflected clockwise or counterclockwise. The micromirror 100 may be rotated around a hinge 120 supported at an anchor or post 110.

FIG. 2 depicts the same three mirrors as in FIG. 1. In the illustrated embodiment both the mirrors 100 and electrodes 130 and 140 are made of silicon. The flexure hinge and the anchors or posts, as well as the reflective surface of the mirror, may be made of silicon. The mirrors may be tiltable when voltage is applied, as is illustrated by central mirror in the example embodiment of the invention in FIG. 2.

FIG. 3 depicts the same three mirrors as depicted in FIG. 1, but with no voltage applied. Even in the absence of voltage some mirrors will tend to tilt due to the difference in surface potential created by electrostatic charges at the silicon surface, as illustrated by the slightly tilted leftmost and middle mirrors in FIG. 3.

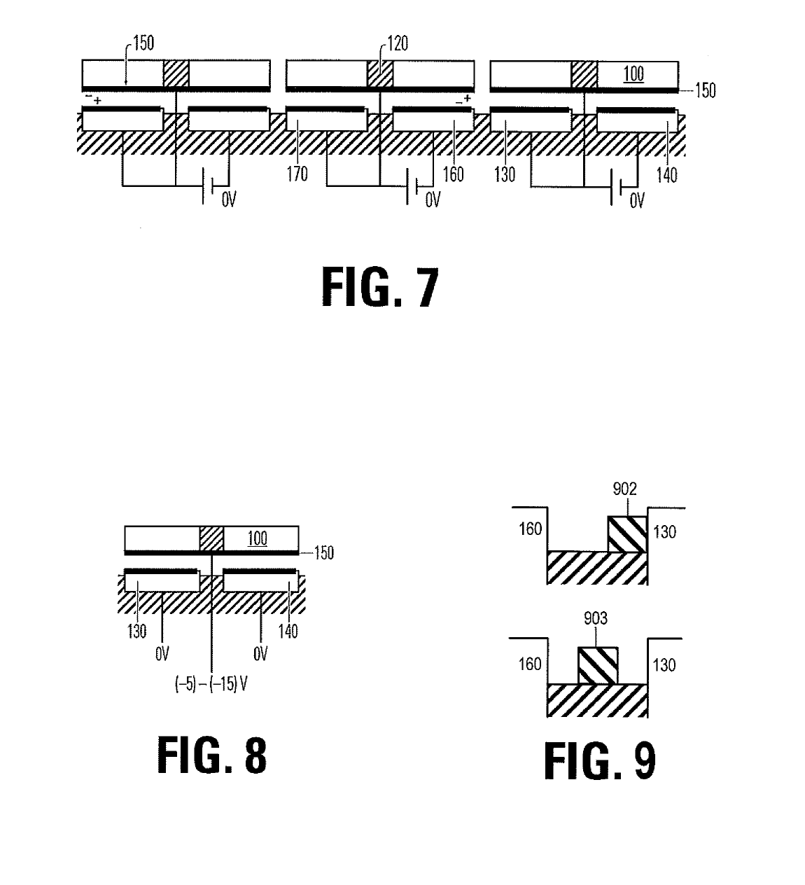

FIG. 7 depicts an embodiment of a micromirror array according to the present invention. Here the electrodes 130 and 140 are provided with a surface layer with a high density of carriers. The surface resistance may be at most 1000 Ω/square. The mirrors 100 are also provided with a surface layer with a high density of carriers. Said surface of the mirrors are facing the electrodes 130 and 140, i.e., the gap between the mirrors 100 and the electrodes 130 and 140. Electrostatic forces may still form on the surface of the semiconducting material in an actuator structure comprising of said mirror element and at least one electrode in the inventive embodiment as illustrated in FIG. 7. However, the resulting surface potential drift may be much smaller, thus the minor deflection may be much smaller.

In at least one example embodiment of the present invention, one or more electrodes and said mirror may be manufactured of a semiconducting material. Said semiconducting material may further be provided with a surface layer in Which a Fermi level falls at an electron energy where it creates a high density of carriers, i.e., inside an allowed band (conduction or valence bands) or in the band gap but close to a band edge. This may in most cases be equivalent to creating a conductive surface layer. In one example embodiment of the invention, a certain level of density of carriers may determine the location of said Fermi level. A high density of carriers may be accomplished in a number of ways, such as by high doping, coating with a conductive layer, inversion or accumulation of the surface by means of doping in the semiconductor, creation of fixed charges in a film, or by electric fields.

FIG. 8 depicts another embodiment of the present invention. In a case where an electric field direction towards the semiconductor can be fixed to always have one sign, the doping of the semiconductor surface may be such that it will always be in accumulation. In FIG. 8 the actuator (the mirror 100 and the electrodes 130 and 140) comprise a silicon side and a metal side. Here, the metal side is the metal electrodes 130 and 140 and the silicon side is the mirror made of silicon or another type of semiconducting material. If the mirror 100 is always negative in relation to the electrode, the semiconducting mirror should be n-doped. Furthermore, the electric field during operation should not approach zero, since a finite field may be needed to assure accumulation even in the presence of charges.

In another embodiment both the electrodes 130 and 140 and the mirror 100 are made of a semiconducting material. In this case the doping of the mirror 100 should be opposite to the electrodes, e.g., an n-doped mirror means a p-doped electrode. It is only during the active (deflection critical) phase that the field must have the specified direction, i.e., at instances in time when the field is used to modulate the light and needs high precision deflection. If the direction of the electrical field is opposite, i.e. a mirror that is always positive, the doping should be reversed, i.e., the mirror should be p-doped and the electrode n-doped if both the mirror and electrode are made of a semiconducting material.

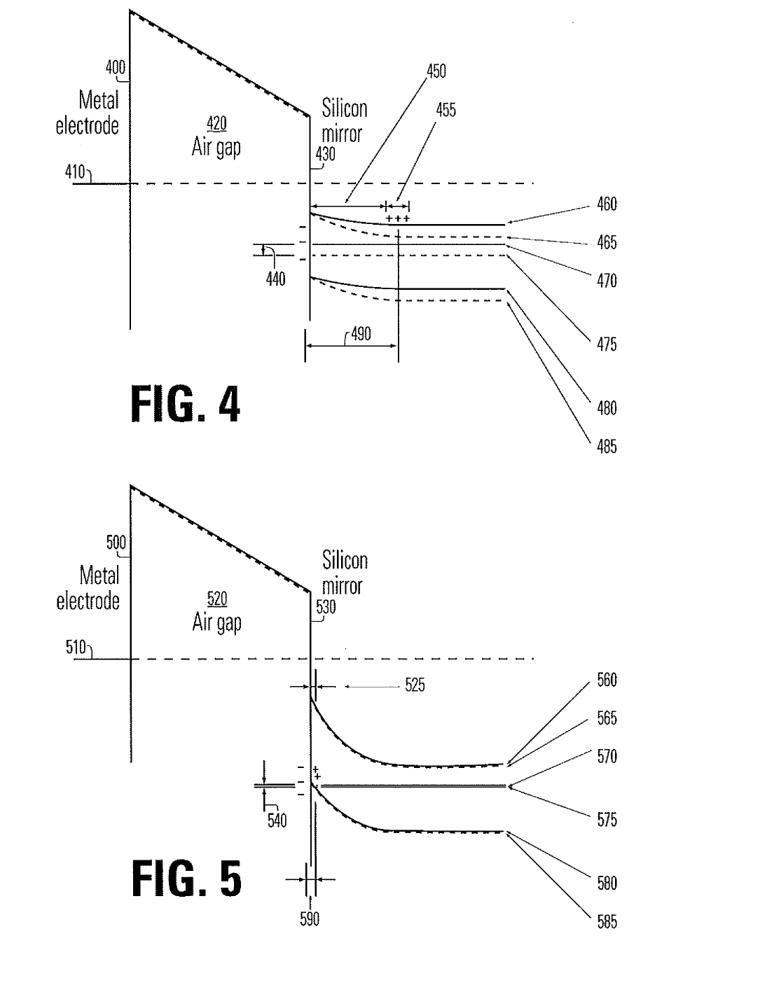

FIGS. 4 and 5 illustrate band diagrams explaining how the invention works. Band diagrams are described in many textbooks on semiconductor physics and MOS technology, for example, S. M. Sze: “Semiconductor Devices Physics and Technology”, John Wiley & Sons Inc, New York (2001) (ISBN 0471333727).

FIG. 4 illustrates the band diagram of an actuator (electrode 500 and minor 430) with metal on one plate (electrode) and an n-doped semiconductor on the other (mirror) separated by an air gap 420. There may be one Fermi level in the metal electrode 410 and another Fermi level in the semiconducting mirror 470. The voltage seen in an external circuit may be the difference in Fermi levels. FIG. 4 illustrates the Fermi levels and various bands with and without surface charges on a surface of the semiconducting mirror 430. When charges are built/added up at the surface, said charges must be balanced by opposite charges. Since an n-doped semiconductor may be depleted close to the surface 450, as may often be the case, the nearest place where balancing charges can be found is on the inner side of the depletion layer. Balancing charges are formed by a change in the depth of the depletion layer 455. Between plus and minus charges there may be an electric field that can be integrated to give the surface potential change on the semiconductor. A change in surface potential may be proportional to the separation of charges 490. As can be seen from FIG. 4, the Fermi level in an n-doped semiconductor without charges 470 may be closer to the Fermi level in a metal 410 than the Fermi level in an n-doped semiconductor with charges 475. It can also be deducted from FIG. 4 that when comparing the bulk material of the mirror a valence band 480 without charges may be closer to the Fermi level in the semiconductor 470 than a valence band with charges 485. Additionally, a conductance band without charges 460 may be further away to the Fermi level 470 in the bulk material of the semiconducting mirror than a conductance band with charges 465.

FIG. 5 illustrates a band diagram of an actuator, a metal electrode 500 and a semiconducting mirror 530 separated by an air gap 520 according to the present invention. A surface of the semiconducting mirror 530 facing the metal electrode 500 may be doped high enough to become degenerated, i.e., said mirror 530 may be said to have metallic properties. In this application metallic properties means that the Fermi level in an example embodiment of the invention is inside an allowed band, here for instance the valence band 580.

In case a conducting layer in an example embodiment of the invention is formed outside of a depleted region, e.g., in an inversion layer, a degenerated surface layer, or a metal layer, said layer can be contacted to the substrate or any other suitable point in order to keep it from electrically floating.

There are movable charges at a surface of the semiconducting mirror 530, and when some charges are added balancing charges can be found right at the surface of said mirror 530. The separation of charges 590 may be much smaller, in the order of nanometers, compared to the separation of charges 490 in the state of the art actuator structure as illustrated in FIG. 4, and thus the surface potential may be much smaller. A smaller surface potential will lead to very small deflection of the mirror when no voltage is applied between the mirror and the electrode. Also, a voltage shift due to charges 540 may be more or less eliminated, due to the fact that the Fermi level in the mirror 570 without charges in one example embodiment of the invention is more or less equal to the Fermi level in the mirror with charges 575. As also can be seen from FIG. 5, the valence band 580 coincides with the valence band with charges 585, and the conductance band 560 coincides with the conductance band with charges.

In FIGS. 4 and 5 it may be assumed that a force between the mirror 430, 530 and the electrode 400, 500 may be constant, i.e., the electric field in the air gap 420, 20, in the actuator is constant. The influence from added charges is shown as a change in Fermi levels, i.e., the external voltage, needed to keep force (deflection of the mirror 430, 530) constant.

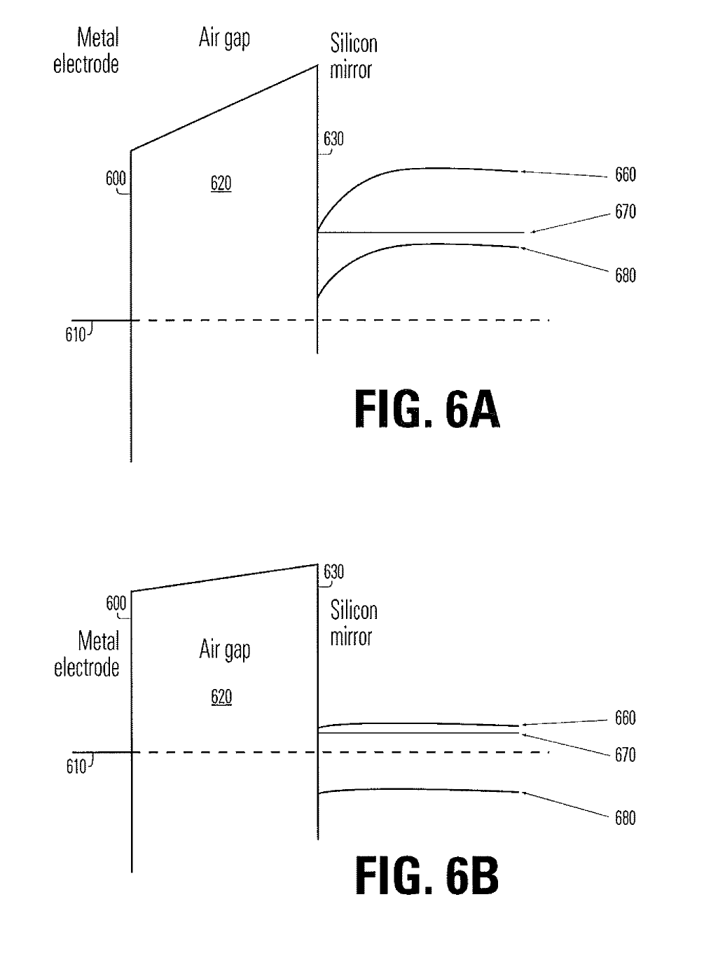

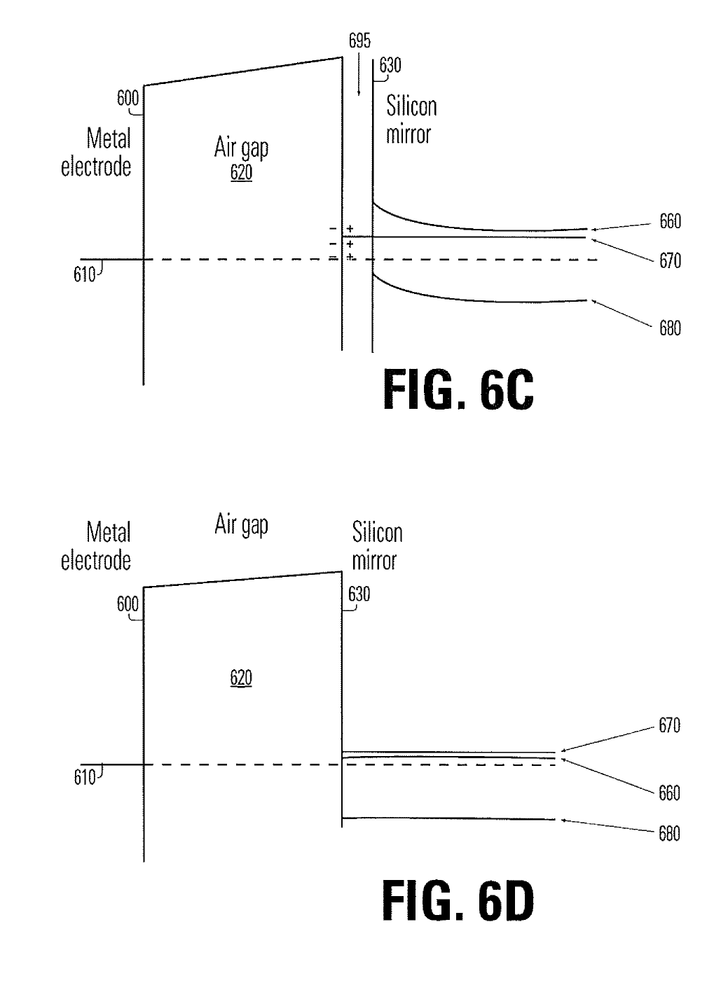

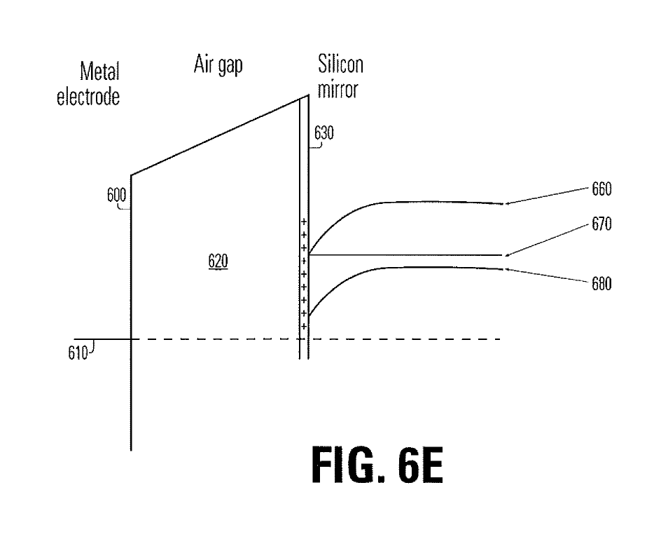

FIGS. 6a-6e illustrate other embodiments of the present invention. In FIG. 6a, a band diagram of a near degenerated inverted p-silicon is shown, The same band diagram would be applicable for a near degenerated n-silicon (inverted or non-inverted) or an enrichment layer. The semiconducting material may be en elemental semiconductor such as silicon, diamond-like carbon, or germanium, or it may be a mixed semiconductor or a semiconducting compound such as silicon-germanium, GaAs, or silicon carbide.

In FIG. 6a the actuator is comprised of an electrode 600 made of a metal, a mirror 630 made of silicon, and an air gap 620 between sad mirror 630 and said electrode 600. The Fermi level 610 in the metal electrode 600 is in the example embodiment of the invention below the Fermi level 670 in the semiconductor. A conductance band 660 at the surface facing towards the metal electrode 600 is closer to the Fermi level 670 in the mirror 630 than to the conductance band 660 in the bulk material of the mirror, i.e., it is deeper into the mirror material. On the other hand, a valence band 680 is further away from the Fermi level 670 at the surface of the minor element 630 facing towards said metal electrode 600 than the valence band 680 in the bulk material is to the same Fermi level 670.

FIG. 6b illustrates a band diagram of an n-silicon mirror, which is driven to create a conductive layer at the surface facing the metal electrode by a perpendicular electric field. The Fermi level in the metal 610 is lower than the Fermi level 670 in the semiconducting mirror 630. A conductance band 660 is closer to the Fermi level 670 at a surface of the semiconducting mirror 630 facing the metal electrode 600 than the Fermi level 670 is to the same conductance band deeper into the semiconducting mirror. However, a valence band 680 is further away from the Fermi level 670 at a surface of the semiconducting mirror 630 than the valence band 680 is to the same Fermi level 670 deeper into the mirror element 630.

FIG. 6c depicts a band diagram of a metal film 695 shielding the semiconducting mirror 630 from charges on the surface facing towards the metal electrode 600. The Fermi level 6 1 0 in the metal electrode 600 is lower than the Fermi level 670 in the semiconducting mirror 630. A conductance band 660 is further away from the Fermi level 670 at the metal film 695 than the conductance band 660 is to the same Fermi level 670 further into the semiconducting mirror 630. The valence band 680 is closer to the Fermi level at the metal film 695 than the valence band 680 is to the Fermi level 670 further into the semiconducting mirror 630.

FIG. 6d illustrates a band diagram of a semiconducting mirror which is degenerated throughout its volume and not only on its surface facing towards the metal electrode. A Fermi level 610 in the metal electrode 600 is below a Fermi level 670 of the semiconducting mirror 630. The Fermi level 670 of the semiconducting mirror 630 is above both a conductance band 660 and a valence band 680 throughout its volume. A distance between said Fermi level 670 and said conductance band 680 is constant throughout the volume as is the distance between said Fermi level 670 and said valence band 660.

FIG. 6e illustrates a band diagram of a near degenerated conducting surface layer generated by a thin film with a high concentration of fixed ions. A Fermi level 610 in the metal electrode 600 is lower than a Fermi level 670 in the semiconducting mirror 630. In this embodiment, the Fermi level 670 at the thin film with high concentration of ions 697 is closer to the conductance band 660 than the Fermi level 670 is to the same conductance band 660 further into the semiconducting mirror 630. The valence band is however further away from the Fermi level 670 at the thin film with high concentration of fixed ions than said valence band is to the same Fermi level further into the semiconducting mirror.

With a density of carriers high enough to create a minimized surface potential of the semiconducting surface in the actuator, the balancing of charges can be done by small physical displacement of carriers. An accumulation or inversion layer should be able to absorb changes of 10¹¹ carriers/cm² without going into depletion. A field in the air gap 620 is typically 10-50 MV/m. This field corresponds to a necessary charge rearrangement of 5-25*10¹⁰ carriers/cm². To absorb this change there should be 10-50*10¹⁰ carriers/cm² close to the surface. To have this amount of carriers within 0.01 μm there is a need for 1-5*10¹⁷ carriers/cm³ in the layer. This gives a rough estimate of the density of carriers needed. The limit for degeneracy which can be estimated around 10¹⁹ carriers/cm³ in silicon.

FIG. 9 includes an area of FIG. 7, such as between electrodes 160 and 130. It illustrates phase step configurations. A phase step has a difference in height between the substrate and the top of the phase step 902, 903, equal to one-quarter wavelength of the illumination source. Stray light reflected from the substrate will be one-half wavelength out of phase with that reflected from the top of the phase step. This phase difference produces diffraction or destructive interference, which minimizes the projection of stray reflected light.

While the present invention is disclosed by reference to the preferred embodiments and examples detailed above, it is understood that these examples are intended in an illustrative rather than in a limiting sense. It is contemplated that modifications and combinations will readily occur to those skilled in the art which modifications and combinations will be within the spirit of the invention and the scope of the following claims.

1. A method for stabilizing against a drift caused by a varying depletion layer of a deflection of a micromirror device having an electrostatic actuator, including the actions of:
providing an actuator including at least two members beneath said micromirror and at least one electrode beneath said micromirror, at least one of said at least two members being formed in a semiconducting material,
providing a surface layer inside said at least one semiconducting member facing towards said other member of said actuator, said surface layer having a density of carriers being 10¹⁷ cm⁻³ or higher

2. The method according to claim 1, wherein the density of carriers is 5*10¹⁷ cm⁻³ or higher.

3. The method according to claim 1, wherein the density of carriers is 10¹⁹ cm⁻³ or higher.

4. The method according to claim 1, wherein said semiconducting material is silicon or germanium or a combination of said materials.

5. The method according to claim 1, wherein said surface layer is conducting.

6. The method according to claim 5, wherein said conducting layer has a surface resistance of at most 1000 ohm/square.

7. The method according to claim 1, wherein said surface layer has metallic properties.

8. The method according to claim 1, wherein said surface layer is a degenerated semiconductor.

9. The method according to claim 13 wherein said surface layer is a layer of the semiconductor in which the distance between a Fermi level and its closest band edge is less than that in the bulk of said semiconductor.

10. The method according to claim 1, wherein said surface layer is an accumulation layer.

11. The method according to claim 1, further comprising the action of
creating said surface layer by an electromagnetic field perpendicular to said surface.

12. The method according to claim 1, wherein said surface layer is a film with built in charges.

13. An SLM including a plurality of electrostatic actuators, said actuators including at least two members beneath a micromirror and at least one electrode beneath said micromirror capable to electrostatically attract said micromirror, at least one of said members being formed in a semiconducting material, wherein at least one of said semiconducting members is provided with a surface layer inside said semiconducting member and facing towards said other member of said actuator, said surface layer having a density of carriers being 10¹⁷ cm⁻³ or higher.

14. The SLM according to claim 13, wherein the density of carriers is 5*10¹⁷ cm⁻³ or higher.

15. The SLM according to claim 13, wherein said density of carriers is 10¹⁹ cm⁻³ or higher.

16. The SLM according to claim 13, wherein said semiconducting material is silicon or germanium or a combination of said materials.

17. The SLM according to claim 13, wherein said surface layer is conducting.

18. The SLM according to claim 17, wherein said conducting layer has a surface resistance of at most 1000 ohm/square.

19. The SLM according to claim 13, wherein said surface layer has metallic properties.

20. The SLM according to claim 13, wherein said surface layer is a degenerated semiconductor.

21. The SLM according to claim 13, wherein said surface layer is a layer of the semiconductor in which the distance between a Fermi level and its closest band edge is less than the distance between said Fermi level and said closest band edge in the bulk of said semiconductor.

22. The SLM according to claim 13, wherein said surface layer is an accumulation layer.

23. The SLM according to claim 13, further comprising the action of
creating said surface layer by an electromagnetic field perpendicular to said surface.

24. The SLM according to claim 13, wherein said surface layer is a film with built in charges.

25. An electrostatic actuator including at least two members beneath a micromirror and at least one electrode beneath said micromirror capable to electrostatically attract said micromirror, at least one of said members being formed in a semi-conducting material, wherein at least one of said semiconducting member is provided with a surface layer inside said semiconducting member and facing towards said other member of said actuator, said surface layer having a density of carriers being 10¹⁷ cm⁻³ or higher.

26. The electrostatic actuator according to claim 25, wherein the density of carriers is 5*10¹⁷ cm⁻³ or higher.

27. The electrostatic actuator according to claim 25, wherein said density of carriers is 10¹⁹ cm⁻³ or higher.

28. The electrostatic actuator according to claim 25, wherein said semiconducting material is silicon or germanium or a combination of said materials.

29. The electrostatic actuator according to claim 25, wherein said surface layer is conducting.

30. The electrostatic actuator according to claim 29, wherein said conducting layer has a surface resistance of at most 1000 ohm/square.

31. The electrostatic actuator according to claim 25, wherein said surface layer has metallic properties.

32. The electrostatic actuator according to claim 25, wherein said surface layer is a degenerated semiconductor.

33. The electrostatic actuator according to claim 25, wherein said surface layer is a layer of the semiconductor in which the distance between a Fermi level and its closest band edge is less than the distance between said Fermi level and said closest band edge in the bulk of said semiconductor.

34. The electrostatic actuator according to claim 25, wherein said surface layer is an accumulation layer.

35. The electrostatic actuator according to claim 25, further comprising the action of:
creating said surface layer by an electromagnetic field perpendicular to said surface.

36. The electrostatic actuator according to claim 25, wherein said surface layer is a film with built in charges.

37. A method for stabilizing against a drift caused by a varying depletion layer of a deflection of an electrostatic actuator comprising at least two elements beneath a micromirror and at least one electrode, at least one of said elements being made of a semiconducting material including the action of:
changing a surface property inside said semiconducting material facing the other element of said actuator such that the absolute value of a surface potential is decreased.

38. The method according to claim 37, wherein said surface has a density of carriers being 1*10¹⁷ cm⁻³ or higher.

39. The method according to claim 37, wherein the density of carriers is 10¹⁹ cm⁻³ or higher.

40. The method according to claim 37, wherein said semiconducting material is silicon or germanium or a combination of said materials.

41. The method according to claim 1, wherein said surface layer is conducting.

42. The method according to claim 41, wherein said conducting layer has a surface resistance of at most 1000 ohm/square.

43. The method according to claim 37, wherein said surface layer has metallic properties.

44. The method according to claim 37, wherein said surface layer is a degenerated semiconductor.

45. The method according to claim 37, wherein said surface layer is a layer of the semiconductor in which the distance between a Fermi level and its closest band edge is less than that in the bulk of said semiconductor.

46. The method according to claim 37, wherein said surface layer is an accumulation layer.

47. The method according to claim 37, further comprising the action of
creating said surface layer by an electromagnetic field perpendicular to said surface.

48. The method according to claim 37, wherein said surface layer is a film with built in charges.

49. A method for stabilizing against a drift caused by a varying depletion layer of a deflection of a micromirror device having an electrostatic actuator, including the actions of:
providing an actuator including at least two members beneath said micromirror and at least one electrode beneath said micromirror, at least one of said at least two members being formed in a semiconducting material,
providing a voltage driving sequence, where during a deflection critical phase an electrical field always has the same direction from or towards each semiconducting surface,
providing a doping of at least one semiconducting surface such that the electrical field during said deflection critical phase creates an accumulation layer.

50. The method according to claim 1, wherein said mirror device is an SLM (spatial light modulator) used for lithographic formation of patterns on a workpiece.

51. The method according to claim 37, wherein said mirror device is an SLM (spatial light modulator) used for lithographic formation of patterns on a workpiece.

52. The method according to claim 49, wherein said mirror device is an SLM (spatial light modulator) used for lithographic formation of patterns on a workpiece.

53. The SLM according to claim 13, further including a phase step between adjoining micromirrors.

54. The SLM according to claim 53, wherein the phase step has a height of one-quarter wavelength of a radiation used to illuminate the SLM.
